(19) United States
(12) Patent Application Publication
(10) Pub. No.: US 2024/0075448 A1
(43) Pub. Date: Mar. 7, 2024

(54) STIRRED TANK REACTOR AND REMOVABLE LINER

(71) Applicant: ODH IP Corp., New York, NY (US)

(72) Inventors: Kersten Rapp, Rockville, MD (US); David Brancazio, Rockville, MD (US)

(73) Assignee: ODH IP CORP., New York, NY (US)

(21) Appl. No.: 17/929,741

(22) Filed: Sep. 5, 2022

(51) Int. Cl. B01J 19/18; B01J 19/00; B01J 19/02

(52) U.S. Cl. CPC B01J 19/18; B01J 19/0013; B01J 19/0066; B01J 19/02; B01J 2219/00033; B01J 2219/00094; B01J 2219/00096; B01J 2219/00099; B01J 2219/00135; B01J 2219/00141; B01J 2219/0295

(57) ABSTRACT

Reactor systems, reactors, and removable liners for chemical and biological processes and manufacturing modules and systems using the same, are disclosed. Kits and methods of using the reactor systems and kits as with removable elements are also disclosed.

### GOVERNMENTAL RIGHTS

This invention was made with government support under DARPA Cooperative Award #HR-0011-16-2-0029 awarded by the Defense Advanced Research Projects Agency of the Department of Defense. The government has certain rights in the invention.

### FIELD OF THE INVENTION

The present invention provides removable reactor liners and chemical and biological reactor systems comprising the removable liners, kits comprising the removable liners and reactor systems, and use thereof.

### BACKGROUND OF THE INVENTION

After each use, chemical and biological reactors and their components must be disassembled, cleaned, reassembled, re-configured, and autoclaved before reuse. This is a time-consuming, laborious process requiring the disassembly and moving of many heavy and/or small and fragile components. Additionally, one generally needs to validate the cleaning procedure to ensure that it is done correctly time after time with the same, consistent, results. At best, after all the work has been completed, one has rendered the reactor and its components aseptically clean, meaning that contamination can still occur by residual organisms or advantageous ones that enter through the aseptic assembly. Reactors are also limited by the material from which they are formed, which should be inert to desired reaction media, and have sufficient mechanical strength to withstand repeated use and high pressures commonly used in chemical and biological reactors. What is needed is a replaceable tank liner that overcomes the deficiencies with the currently available reactors.

### SUMMARY OF THE INVENTION

[Polsinelli will complete this section before filing]

### BRIEF DESCRIPTION OF THE FIGURES

FIG. 1 depicts a diagrammatic representation of a generic chemical and biological tank reactor.

FIG. 2 is a top perspective view of an aspect of a reactor of the instant invention. In this aspect, the reactor is a CSTR.

FIG. 3 is an exploded view of an aspect of a CSTR of the instant invention shown in FIG. 2.

FIG. 4 is a longitudinal cross section view of an aspect of the CSTR of the instant invention shown in FIG. 2.

FIG. 5A is a top perspective view of an aspect of a liner of the instant invention comprising a lip.

FIG. 5B is a bottom perspective view of an aspect of a liner of the instant invention comprising a lip.

FIG. 6 is a cross section view of an aspect of a reactor system of the instant invention, further comprising a stirrer.

FIG. 7 is a cross section view of an aspect of a reactor system of the instant invention, further comprising a stirrer and baffles attached thereon.

FIG. 8 is a cross section view of an aspect of a CSTR of the instant invention, further comprising a temperature control jacket.

FIG. 9 is a cross section view of an aspect of a CSTR of the instant invention, further comprising a temperature control jacket and a stirrer.

FIG. 10 schematically depicts a chemical process of synthesizing cisatracurium besylate.

FIG. 11A depicts synthesis of racemic R,S,-tetrahydropapverine (TP) precursor in the synthesis of cisatracurium besylate using a system comprising a STR of the instant invention.

FIG. 11B depicts separation of racemic R,S,-tetrahydropapverine (TP) with R,S naproxen to the R and S stereoisomers to produce the R-tetrahydropapaverine naproxen salt.

FIG. 12 depicts synthesis of ciprofloxacin in a pharmaceutical on demand (POD) unit.

### DETAILED DESCRIPTION

The reactor liners, reactors, reactor systems, reactor controllers, and methods of using thereof will be understood from the accompanying drawings, taken in conjunction with the accompanying description. It is noted that, for purposes of illustrative clarity, certain elements in various drawings may not be drawn to scale. Several variations of the system are presented herein. It should be understood by those of skill in the art, that various components, parts, and features of the different variations may be combined together and/or interchanged with one another, all of which are within the scope of the present application, even though not all variations and particular variations are shown in the drawings. It should also be understood that the mixing and matching of features, elements, and/or functions between various variations is expressly contemplated herein so that one of ordinary skill in the art would appreciate from this invention that the features, elements, and/or functions of one variation may be incorporated into another variation as appropriate, unless described otherwise.

### I. Reactor Liners and Reactor Systems

The instant invention is directed to removable reactor liners (also referred to herein as reactor liners and removable liners), reactors, and reactor systems comprising the removable reactor liners to carry out any chemical or biological reaction or fermentation in a reaction medium under controlled conditions. The reactor liners of the instant invention form a reaction compartment in a reaction chamber of a reactor by lining the interior surface of the reactor chamber. The liners are removable and replaceable, are generally chemically and biologically inert, and can be replaced with another liner after a production run, thereby facilitating the ability to quickly accommodate different reactions being performed in the reactor. Additionally, because reactions in the reactor system occur in the reaction compartment of the chemically and biologically inert liner, a reactor system comprising a liner of the instant invention provides for the use of reactors constructed from any appropriate material, including non-chemically and non-biologically inert material.

The reactor of the reactor systems of the instant invention can be any stirred tank reactor (STR, also referred to herein as “reactor”) type where controlled reaction conditions can be achieved. The reactor can be a batch reactor or a semi batch reactor. In batch reactors, the reactants are added to the reactor at the start of the reaction and are allowed to react for a fixed period of time. No feed is added, or product withdrawn during this time. The reaction products are removed at the end of the batch. Semi batch (semiflow) reactors operate much like batch reactors in that they take place in a single stirred tank with similar equipment. However, they are modified to allow reactant addition and/or product removal in time. The reactor can also function as a continuous stirred tank reactor (CSTR), also known as a vat- or backmix reactor, a mixed flow reactor (MFR), or a continuous-flow stirred-tank reactor (CFSTR). In a CSTR, one or more reagents are continuously introduced into the reactor in a reactor input stream and stirred to ensure proper mixing of the reagents in the reaction medium. CSTRs are run at steady state and a uniform composition is assumed throughout each reactor. In some aspects, the reactor is a batch reactor. In other aspects, the reactor is a semi batch reactor. In yet other aspects, the reactor of the reactor systems of the instant invention is a CSTR.

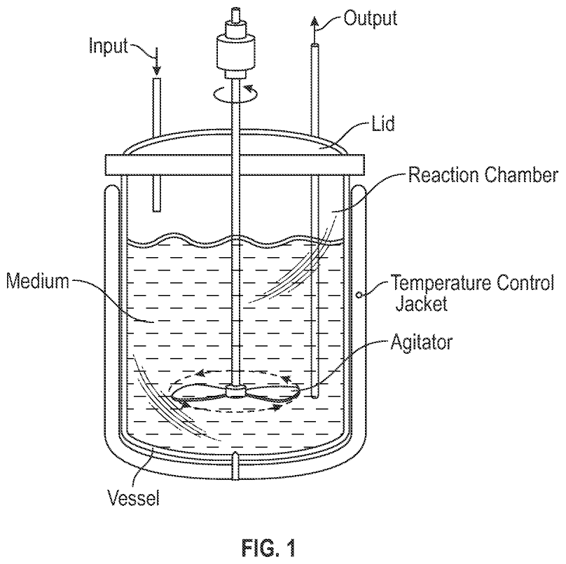

A depiction of a generic aspect of a reactor is shown in FIG. 1 for illustration purposes. The reactor comprises three major components: (1) a reactor vessel, (2) a reaction chamber, and (3) agitation. In this aspect, a temperature control jacket to heat and/or cool the contents of the reactor is also shown. In a reactor, one or more reagents are introduced into the reactor continuously or in batches to produce a reaction medium and stirred to ensure proper mixing of the reagents in the reaction medium. The reaction medium is optionally subjected to reaction conditions to cause an intended reaction between the reagents, and products are continuously removed. Reactors can be run at steady state, and a uniform composition is assumed throughout each reactor.

The reactor liner provides the chemical inertness while the reactor provides mechanical strength (for repeatable lid closure and to tolerate high pressures, for example), thermal properties, and ability to add ports and other components for appropriate functioning of the reactor system. Reactor liners and reactor systems of the instant invention can be used to carry out any chemical or biological reaction or fermentation where controlled reaction conditions are required. The reactions may include hydrogenations, polymerizations, synthesis of chemical compounds such as pharmaceuticals, catalytic reactions, petrochemical, crystallization, enzymatic reactions, and nanoparticle synthesis, among others. Reactor liners and reactor systems comprising the removable reactor liners can also be used as bioreactors or fermenters to conduct biological processes such as cell culture, production of secondary metabolites and the like. Typical non-limiting applications include brewing, pharmaceuticals, wastewater treatment, biologicals, biopharmaceuticals, tissue engineering, microorganisms, plant metabolites, food production, and hydrocarbon processing such as in the petrochemical industry, among others.

In some aspects, the reactor of the reactor system of the instant invention is a CSTR. In a CSTR, the time required to process one reactor volume of fluid, also known as the space time, can be calculated by dividing the volume of the tank by the average volumetric flow rate through the tank. Using chemical kinetics, the reaction's expected percent completion can be calculated.

Considering the continuous flow of reagents through a CSTR reactor, residence time control in a CSTR can be poor, as each molecule does not necessarily flow through the reactor at the same rate. Better control over residence time can be achieved by connecting two or more CSTRs in series wherein the product output stream from a first reactor is the input stream of a second reactor. Accordingly, an aspect of the invention comprises a reactor assembly comprising more than one CSTR reactor assembled in series. A reactor assembly can comprise 2, 3, 4, 5, 6, 7, 8, 9, 10, or more reactor systems comprising removable liners assembled in series.

The size and shape of the removable liner, the vessel, the lid, the reaction chamber in the reactor, as well as the enclosed space and reaction compartment in the removable liner, can and will vary based on the intended use of the reactor system of the instant invention and equipment with which the reactor system is used. For instance, the size and shape of the reactor and removable liner can be designed to accommodate an optimal residence time and reaction conditions (heat and mass transfer) to optimize the reaction, or to accommodate space restrictions in applications such as standalone chemical and pharmaceutical production systems. Similarly, the size and shape of the reactor and removable liner can and will vary considerably to accommodate a desired volume of reaction media in the reaction compartment. As reactor systems can have uses in diverse fields such as within the food, chemical, and pharmaceutical industries, the size of a reactor and removable liner can and will vary considerably. In some aspects, reaction volumes of tens of thousands of liters are common. In some aspects, the instant reactor systems can provide a reactor and removable liner comprising a reaction compartment that can accommodate a volume of reaction media ranging from less than about 1 mL to about 4 Ls or more. In some aspects, the instant reactor can provide a volume ranging from less than about 1 mL to about 3 L, from about 1 L to about 3 Ls, from about 1 mL to about 3 Ls, from about 1 mL to about 20 mL, from about 10 mL to about 400 mL, from about 50 mL to about 400 mL, from about 100 mL to about 500 mL, from about 200 mL to about 500 mL, from about 300 mL to about 500 mL, from about 100 mL to about 400 mL, from about 100 mL to about 300 mL, or from about 150 mL to about 250 mL.

### (a) Reactor

A reactor system of the instant invention comprises a reactor comprising a vessel, and a lid. A reactor of the instant invention can be used with the reactor liner of the reactor systems of the instant invention. The vessel comprises a vessel opening and an interior surface defining an interior space in which the interior surface is covered by the removable liner. The vessel also comprises a sealing rim defining the opening of the vessel. During operation, the opening of the vessel can be releasably sealed with the lid at the sealing rim, forming an enclosed, tightly sealed reaction chamber within the reactor and a reaction compartment within the removable liner.

The lid is releasably sealed to the removable liner and the vessel by mechanical closure. As it will be understood by individuals of skill in the art, the seal is fluid- and pressure-tight to prevent contamination and loss of material and to provide controlled conditions for an intended use of the reactor, such as temperatures, gases, and positive or negative pressures in the chamber. Suitable mechanical closures are known in the field of reactors in general and CSTRs specifically, and generally comprise a means of engaging the rim of the vessel and the lid to bring the lid into sealing contact with the rim of the vessel to form a seal at the point of contact between the lid, the removable liner, and the sealing rim. Mechanical closures include those normally used in applications where purity, contamination, and cleanability are of paramount importance such as in the pharmaceutical industry, food industry, and the like. Non-limiting examples of mechanical closures include a sanitary clamp or other suitable union such as clamps or unions of conventional design, including band clamps, sanitary clamps such as Ladish, Tri-Clover clamps, Tri-Clamps, S-Clamps, 3A pipe fittings, mated threads on the lid and sealing rim, nuts and bolts, clips, or any combination thereof. Seals, gaskets, and O-rings can also be designed and used to ensure a tight seal between the cover, the removable liner, and the sealing rim. The material of the seals, gaskets, O-rings, or any combination thereof is generally inert to the reaction medium. For instance, the material can be elastomers, neoprene, EPDM rubber (ethylene propylene diene monomer rubber), coated elastomers such as fluoropolymer-coated elastomeric gaskets, such as PTFE-coated Viton™, and silicone encapsulated with fluorinated ethylene propylene (FEP) or a perfluoroelastomer such as Kalrez™. Other means of ensuring a fluid-tight seal between the cover and sealing rim can be envisioned. In some aspects, the reactor comprises a gasket interposed between the removable liner, the lid, and sealing rim of the vessel.

It will be understood that all the components of the reactor can be constructed from materials that meet the requirements of a desired process. The components can be constructed of the same or different materials based on the intended use of the reactor, and are known to individuals of skill in the art. Non-limiting examples of materials include metals, including but not limited to steel, metal alloys such as Hastelloy™ and Inconel™, stainless steel, and aluminum, as well as glass, ceramics, and plastics such as polyetheretherketone (PEEK), high density polyethylene (HDPE), polypropylene (PP), and fluoropolymers such as PVF (polyvinylfluoride), PVDF (polyvinylidene fluoride), PTFE (polytetrafluoroethylene; Teflon™), PCTFE (polychlorotrifluoroethylene), PFA or MFA (perfluoroalkoxy polymer), FEP (fluorinated ethylene-propylene), ETFE (polyethylenetetrafluoroethylene), ECTFE (polyethylenechlorotrifluoroethylene), FFPM/FFKM (perfluorinated elastomer [perfluoroelastomer]), FPM/FKM (fluoroelastomer [vinylidene fluoride based copolymers]), FEPM (fluoroelastomer [tetrafluoroethylene-propylene]), PFPE (perfluoropolyether), perfluoropolyoxetane, or any combination thereof. In some aspects, it could be beneficial to construct the components from, or can-comprise portions made of thermally conductive material or material that can withstand pressures that may accumulate in the process chamber. It is noted that, because reactions in the reactor system occur in the reaction compartment of the chemically and biologically inert liner, the reactor vessel, lid, or both can even be constructed from non-chemically and non-biologically inert material. Accordingly, a wider selection of materials, even non-chemically resistant material, can be used to construct reactor components.

In some aspects, the vessel, lid, or both can be constructed from, or can comprise portions made of thermally conductive material, material that can withstand pressures that may accumulate in the reaction chamber, or a combination of both.

A reactor vessel, lid, or both, can be constructed from or can comprise portions made of translucent/transparent material for observation during the reaction process, and/or to allow the user to direct specific electromagnetic energy at a specific wavelength into the crystallizer portion to participate in the reaction process. An example of electromagnetic energy can be UV light to help catalyze a polymerization reaction. Further, the translucent/transparent material can be measurement regions that can accommodate one or more detectors, or one or more conductive areas having different conductive properties. Non-limiting examples of detectors can be as described in Section I(e) herein below, and can include a camera, an optical microscope, an electron microscope, a spectrometer, or combinations thereof.

It will be recognized that the reactor can further comprise additional components or parts known to individuals of skill in the art suitable for the intended function of the reactor. Non-limiting examples of additional components or parts can be as described in Section I(e) herein further below.

### (b) Removable Reactor Liner

The reactor systems of the instant invention comprise a removable liner for removably lining the interior surface of the reaction chamber. The removable liner comprises a body defining an interior space in the liner and an opening. The liner can conform to the surface of the reaction chamber in order to prevent wrinkles which may contribute to discontinuity in the circulation within the device or to prevent the formation of dead spots or pockets in which material may get trapped and fester or create uneven flow in the reactor. The interior space of the liner forms a reaction compartment in the enclosed reaction chamber of the reactor. The liner is removable and can be replaced after a production run with another removable liner, thereby facilitating the ability to quickly accommodate different reactions being performed in the reactor. Since the removable liner prevents the reagents in the reaction compartment from contacting the vessel, the vessel need not be cleaned, sterilized, and validated before reusing the reactor for another production run. Instead, a new removable liner is placed in the reactor for the new production run. The liner can be disposable and/or re-usable after appropriate cleaning, e.g., during another reaction run.

The liner can line the entirety of the interior surface of the reaction chamber, including the internal surface of the lid. In some aspects, the liner is operable to line the interior surface of the vessel. In some aspects, the liner comprises a liner body operable to removably line the interior surface of the vessel, and a removable liner lid operable to removably line the interior surface of the lid. Alternatively, the removable liner can line a portion of the interior surface of the reaction chamber. When the liner lines a portion of the surface of the reaction chamber, the opening of the liner is not coincident with the opening of the vessel. In such aspects, the liner can further comprise a rim surrounding the liner opening to strengthen the opening of the liner and prevent collapse. In such aspects, the liner rim material can be the same or different from the material forming the body of the liner.

When the liner lines the entirety of the surface of the reaction chamber, the opening of the removable liner is coincident with the opening of the vessel. In such aspects, the removable liner can further comprise a lip surrounding the liner opening. The lip can be interposed between the lid and the body at the sealing rim, thereby securing the removable liner in the reactor when the vessel lid is secured to the vessel rim. It can be envisioned that when the lip is interposed between the lid and the sealing rim, the lip can also aid in providing a tight seal between the cover and sealing rim when used alone or in combination with other means of providing the tight seal described herein below. In such aspects, the lip material can be the same or different from the material forming the body of the liner.

It will be recognized that the removable liner exhibits properties that do not impede a chemical or enzymatic reaction. For instance, the removable liner can be made of inert material, and/or of a thickness that does not impede temperature conduction among other reaction parameters. For instance, the thickness of the removable liner can range from about 0.001 to about 0.1 inches, from about 0.002 to 0.02 in, or from about 0.05 to 0.08 in. In some aspects, the thickness of the liner can be 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1 inches or more. Other thicknesses can also be used.

The removable liner material can be any chemically inert material or combination of materials that meet the requirements and reaction conditions of a desired process such as extreme temperatures and pressure, and harsh chemical environments. Non-limiting examples of materials include metals, including but not limited to steel, metal alloys such as HasteHoy™ and Inconel™, stainless steel, and aluminum, as well as glass, ceramics, and plastics such as polyetheretherketone (PEEK), high density polyethylene (HDPE), polypropylene (PP), and fluoropolymers such as PVF (polyvinylfluoride), PVDF (polyvinylidene fluoride), PTFE (polytetrafluoroethylene; Teflon™), PCTFE (polychlorotrifluoroethylene), PFA or MFA (perfluoroalkoxy polymer), FEP (fluorinated ethylene-propylene), ETFE (polyethylenetetrafluoroethylene), ECTFE (polyethylenechlorotrifluoroethylene), FFPM/FFKM (perfluorinated elastomer [perfluoroelastomer]), FPM/FKM (fluoroelastomer [vinylidene fluoride based copolymers]), FEPM (fluoroelastomer [tetrafluoroethylene-propylene]), PFPE (perfluoropolyether), perfluoropolyoxetane, or any combination thereof. In some aspects, the materials include metals, including but not limited to steel, metal alloys such as Hastelloy™ and Inconel™, stainless steel, aluminum, as well as plastics such as polytetrafluoroethylene (PTFE), perfluoroalkoxy (PFA of Teflon™), and polyetheretherketone (PEEK), ceramics, and glass.

In some aspects, the reactor liner is constructed of polymer film. Polymer film can include without limitiation, low-density polyethylene or other polymeric sheets, fluoropolymers, or combination of fluoropolymers. Fluoropolymers are fluorocarbon-based polymers with multiple carbon-fluorine bonds and can be prepared from the following monomers: perfluorocycloalkene (PFCA), ethylene (Ethane) (E), vinyl fluoride (fluoroethylene) (VF1), vinylidene fluoride (1,1-difluoroethylene) (VDF or VF2), etrafluoroethylene (TFE), chlorotrifluoroethylene (CTFE), propylene (P), hexafluoropropylene (HFP), perfluoropropylvinylether (PPVE), perfluoromethylvinylether (PMVE). Fluoropolymers are characterized by a high resistance to solvents, acids, and bases. Non-limiting examples of suitable fluoropolymers include polytetrafluoroethylene (PTFE), also known as Teflon, ethylene-tetrafluoroethylene (ETFE) or perfluoroalkoxy copolymer (PFA), and fluorinated ethylene propylene (FEP).

In some aspects, the reactor liner is manufactured using medical grade polymer film for which regulatory documentation for the film may be currently available. For instance, the polymer film can be a polymer classified using the USP In Vivo Biological Reactivity Tests (Class I-VI Plastics Tests). In some aspects, the reactor liner is manufactured using medical grade USP Class IV polymer film.

The removable liner can be moldable or thermoformable and can be comprised of a single ply material or can comprise two or more layers which are either sealed together or separated to form a double walled removable liner. Where the layers are sealed together, the material can comprise a laminated or extruded material. The laminated material can include two or more separately formed layers that are subsequently secured together by an adhesive. The extruded material can include a single integral sheet having two or more layers of different material that are each separated by a contact layer. All the layers can also be simultaneously co-extruded.

As with the reactor, a removable liner can be constructed from or can comprise portions made of translucent/transparent material for observation during the reaction process, and/or to allow the user to direct specific electromagnetic energy at a specific wavelength into the reactor portion to participate in the reaction process.

### (c) Ports

The removable liner, the reactor, or both, further comprise one or more ports in fluid communication with the reaction chamber of the reactor and the reaction compartment of the removable liner for inserting tubing for material input and output as well as for attaching sensors, filters, connectors, probes, samplers, or other devices. Devices include but are not limited to a filter, a connector, a probe, a sensor, a sampler, and other devices described in Section I(e). The incorporation of various ports into the removable liner, the reactor, or both allows for gas flow in and out of the reactor, as well as liquid flow in and out of the reaction chamber of the reactor and the reaction compartment of the removable liner. For instance, ports can accommodate headspace gas in, headspace gas out, sparge gas in, reactants and solvents in, catalyst in, culture media in, titrant in, inoculum in, nutrient feeds in, harvest out. It will be understood that the tubing and sensors can be connected to the ports by using any desirable connection technology capable of providing a seal at the port. For instance, ports can comprise industry standard thread sizes that can be used for attaching various components and tubing to the reactor and or liner. Non-limiting examples of industry standard thread sizes are the American National Standard Pipe Thread standard, British Standard Pipe threads, ISO 7-1, 7-2, 228-1, and 228-2 threads, among others. In some aspects, the ports comprise national pipe standards screw threads. They include both tapered and straight thread series for various purposes, including rigidity, pressure-tight sealing, or both. The types are named with a symbol and a full name. Examples of the symbols include NPT (national pipe taper), NPS (National pipe straight), NPSI (National pipe straight-intermediate), NPSC (National pipe straight-coupling), NPSL (National pipe straight-locknut), and NPSM (National pipe straight-mechanical), among others. In some aspects, the ports comprise Female National Pipe Taper (FNPT).

The ports can be located anywhere in the reactor. It will be recognized that if a port is at a location in the body of the reactor lined by the liner, the ports in the lining can further comprise connection technology capable of providing a seal at the port In some aspects, the ports are located in the reactor body at a region above the opening of the liner such that insertion of the tubing or the device accesses the reaction chamber at a location above or through the opening of the liner. In some aspects, the two or more ports are in the lid of the body of the reactor. In some aspects, the ports are located in the reactor body at a region lined by the removable liner such that insertion of the tubing or the device accesses the reaction chamber at a location through the liner body.

The one or more ports can comprise at least one material input port through which reaction material can be introduced to the reaction chamber, and can comprise at least one material output port through which reaction product or other components of the reaction medium can be harvested or sampled. The input port can comprise tubing inserted through ports into the reaction medium, or into the headspace of the reactor. Material output ports comprise tubing inserted through ports into the reaction medium. As distribution of the reaction media is not uniform throughout a reaction chamber and/or compartment of a, the end of the material output tubing in the reaction media can be at a point where product concentration is expected to be highest. The end of the material output tubing in the reaction media can also be at the bottom of the reaction compartment to be capable to remove all the reaction media from the reaction compartment.

In some aspects, in addition to the material input ports and output ports, the reactor system of the instant invention comprises an attachment port for attaching other components such as sensors, filters, connectors, probes, samplers, among others. In some aspects, the reactor system comprises an attachment port for attaching an agitator to the reactor. In some aspects, the reactor system comprises an attachment port for attaching a pressure relief valve.

### (d) Agitation

The reactor system of the instant invention can comprise an agitator for agitating the reaction media in the reaction compartment of the reactor liner to ensure that sufficient agitation/stirring of a reaction medium can occur. Agitators can also be very useful in heat transfer applications when it is important that the fluid closest to the wall moves at high velocities. Suitable agitators are readily known to individuals of skill in the art. Non-limiting examples of suitable agitators include overhead stirrers, magnetic stirrers, and a shaking device such as a device similar to a paint shaker. A reactor system can also function as a loop reactor which, when heated, pressurized fluid is injected into the system to facilitate the stirring. This allows for higher heat and mass transfer rates while simplifying maintenance because there is no agitator.

In some aspects, the agitator is an overhead stirrer. An overhead stirrer generally comprises a shaft which extends through a port (mixing port) into the reaction compartment and the reaction medium. The shaft comprises an impeller disposed in the reaction medium for stirring or agitating the reaction medium. The impeller can be paddle shaped, or any other conventional form known within the bioreactor/fermenter art. For instance, the impeller can be a Rushton, a marine, a hydrofoil, or a pitched blade impeller.

Impellers can be classified as either laminar (viscous) or turbulent impellers. The type and geometry of impeller used will vary from process to process and can be determined experimentally. For situations involving very viscous fluids where laminar mixing is present, the diameter of the impeller can approach the diameter of the tank. The larger impellers aid in the transport of momentum throughout the tank and ensure that the fluid is moving close to the tank wall. Some common but non-limiting geometries of laminar impellers are the ribbon impeller, the screw impeller, and the anchor impeller.

Some common but non-limiting geometries for radial flow mixers include disk style flat blade turbines and curved blade turbines, while some common axial flow impellers are the propeller and pitched blade turbine. Turbulent mixers can be further categorized as axial or radial flow impellers, among other types. Axial flow impellers cause the tank fluid to flow parallel to the impeller's axis of rotation, while radial flow impellers cause the tank fluid to flow perpendicular to the impeller's axis of rotation. Axial flow impellers can be further broken down into paddle, turbine, screw-type, helical blade, anchor, gate propeller, to name but a few. Axial flow impellers are very useful in mixing solid-liquid suspensions because they prevent the solid particles from settling at the bottom of the tank. Radial flow impellers should be used in situations where high shear rates are needed, such as in dispersion processes.

For driving the stirrer, a motor or other driving device may be employed, typically outside the reactor body. Any motor capable of providing the appropriate torque, speed and power can be used in a device of the instant invention. For instance, a motor of the instant invention can be a brushed DC electric motor, a brushless DC electric motor, a fractional horsepower motor, a servo motor, a three-phase AC synchronous motor, a stepper motor, or any combination thereof. In some aspects, the motor is a stepper motor. In other aspects, the motor is a 12-24V stepper motor with a shaft diameter ranging from about 0.2 to about 1 inch. In one aspect, the motor is a 01164 NANOTEC, NEMA 23 STEPPER MOTOR WITH ENCODER, 24 VDC, 264.81 OZ-IN TORQUE, 0.25IN DIA SHAFT. In another aspect, the motor is a Yamato LM200 stirrer attached to the vessel through a modified lid with a 24/40 connection.

It will be noted that a motor can further comprise parts operable to improve or adjust the performance of the motor or improve or adjust the connection of the motor to the agitator assembly and the vessel. For instance, the motor can further comprise a gearbox to adjust speed and torque to suit the needs of a process in the process chamber. For instance, a gearbox can be added to a motor to decrease the speed of the motor and increase the torque to suit process needs. Further, the motor can comprise a flexible coupling connecting the motor to the shaft of the agitator assembly. The function of a flexible coupling is to transmit torque from the motor to the agitator assembly shaft while making allowances for minor shaft misalignment and shaft end position changes between the two machines. In some aspects, the agitator assembly shaft is connected to the motor using a flexible coupling. In some aspects, the flexible coupling is a Ruland PCR20-8-4-SS. For additional stability of the stir blade, bearings could be added to the lid/motor coupling housing for a more rigid impeller

In some aspects, the agitator is a magnetic stirrer or magnetic mixer. A magnetic stirrer employs a rotating magnetic field to cause a stir bar (or flea) immersed in the reaction medium to spin, thereby mixing the contents of the reaction medium. The rotating field may be created either by a rotating magnet or a set of stationary electromagnets, placed beneath the vessel of the reactor body.

In a cylindrical reactor comprising a center-mounted mixer, a very inefficient flow pattern is generated: the tangential velocities from the impeller cause the entire fluid mass to spin. In other words, the entire fluid (and its solids) moves like a merry-go-round. In solid suspension applications, the solid particles will swirl around at the bottom of the tank: no axial (top to bottom) flow is created to lift them up and suspend them in the fluid. Accordingly, the reactor system can further comprise elements, or can be configured to improve efficiency of mixing the reaction medium by the agitator. Non-limiting examples of configuring agitation components to optimize mixing include the addition of baffles in the reaction compartment or adjusting the mounting configuration of the stirrer. In some aspects, agitation in a reactor system is configured to optimize mixing of reaction components using agitation components and configurations known to individuals of skill in the art.

In some aspects, a reactor of the instant invention further comprises baffles. As used herein, the term “baffle(s)” refers to structures in the reaction compartment to promote mixing by preventing vortexes from forming during agitation. Baffles can be long “plates” of various shapes, sizes, and configurations in the reaction chamber that prevent swirling & promote top to bottom fluid movement. They are most commonly used for blending and solid suspensions because these applications often use vertical, cylindrical tanks that tend to create swirling patterns, regardless of the type of impeller being used. Baffle configurations can and will vary depending on the reactor type and size, the reaction medium characteristics, such as viscosity and volume of the reaction medium, and the stirring mechanism used in conjunction with the baffles, and are known to individuals of skill in the art. For instance, the number of baffles, the width of baffles, and the mounting positions of the baffles in the reaction compartment are parameters that can be adjusted to get the best mixing. It is noted that square or rectangular blending tanks are self-baffling and may not need baffles. Baffles can be attached to the interior surface of the reactor vessel, the reactor lid or the impeller of the agitator. Alternatively, baffles can be attached to the interior surface of the removable liner and can be made of the same or different material from the liner. In an aspect, the baffle configuration can be as described in Section I(f). Efficient mixing can also be ensured by adjusting the mounting of the mixer in the reaction chamber. With axial-flow impellers, an angular off-center position where the impeller is mounted approximately 10-15° from the vertical, can be used. Alternatively, the mixer can be offset while being placed vertically in the tank. The mixer can also be positioned at an angle and offset.

In some aspects, the reactor system of the instant invention comprises controllers for adjusting the speed of agitation to accommodate various reaction conditions and reactor configurations. Non-limiting examples of controllers for adjusting the speed of agitation include adjusting the speed of rotation of an impeller or magnetic stirrer using a variable speed driver. The variable speed driver can be an adjustable frequency AC controller, a DC motor and drive, a steam turbine driver, or a hydraulic variable speed drive unit (“fluid drive”). In some aspects, the agitator arm is vertically movable, and the agitator assembly comprises components, such as a hydraulic system, for independent raising and lowering of the rotating agitator arms for performing the various functions.

### (e) Other Components

As described above, the reactor system can further comprise sensors, filters, connectors, probes, samplers, connectors for attaching the reactor to additional devices or systems, other devices, or any combination thereof. In some aspects, the reactor system comprises connectors for attaching the reactor system to miniature chemical or pharmaceutical manufacturing units, a pharmaceutical on demand (POD) unit, or a portable formulating apparatus.

Non-limiting examples of sensors that may be used in conjunction with CFWD devices of the instant invention include sensors for fluid flow, temperature, pH, oxygen, pressure, concentration, and sensors that can detect specific compounds in a reaction medium. Fluid flow sensors can sense the rate of reagent or solvent addition which can be adjusted in an adaptive response to real time, or near real time, touchless measurements. Other devices can include pressure relief or other valves such as rupture disks, connectors such as Luer connectors, compression fittings, quick disconnects, aseptic G sterile connectors and other such fitting that would allow for the creation of sterile connections, septums for sampling, filters, bearings such as agitator shaft bearings and bearing assemblies, viewports, and probe ports. Reactor systems of the instant invention can also comprise devices such as light emitting diodes (LEDs) that direct specific electromagnetic energy at a specific wavelength into the crystallizer portion to participate in the reaction process. Such devices can direct the energy through portions in the vessel made of translucent/transparent material. Alternatively, electromagnetic energy devices can be embedded into the side walls of the vessel.

The reactor can further comprise contact or contactless measuring systems, which may comprise instruments operable to measure, for example, quantity (i.e., volume, weight, etc.), analyte identity and/or concentration, flow rate, temperature, pressure, turbidly, color, reagent use, reagent verification, and product verification. The measurement of the reactants or reaction in the process chamber may be performed using spectroscopic analysis, ultrasonic detection, or optical detection. Reagent verification, product verification, analyte identity and concentration analysis within the process chamber may be performed using a range of analytical instruments, such as liquid chromatography (LC), MS high performance liquid chromatography (HPLC) with or without UV-VIS, UV-VIS-DAD, and/or mass spectrometry detectors, electromagnetic radiation spectroscopy, such as UV/Vis NIRF, FTIR, and RAMAN, and combinations thereof.

In some aspects, the reactor system comprises contactless measurement systems for the reactants, or reaction in the CFWD device may be performed using spectroscopic analysis, ultrasonic detection, or optical detection. In some aspects, reagent verification, product verification, analyte identity, and concentration analysis within the process chamber of the CFWD device used in the contactless measuring systems may be performed using liquid chromatography (LC), MS high performance liquid chromatography (HPLC) with or without UV-VIS, UV-VIS-DAD and/or mass spectrometry detectors, electromagnetic radiation spectroscopy, such as UV/Vis NIRF, FTIR, and RAMAN, and combinations thereof.

The reactor system can further comprise measuring devices for tracking fluid volume and/or flow rate within the reactor system using ultrasound or camera and machine vision. Ultrasonic fluid level measurement may be performed, for example, using GL Sciences Liquid Level Sensor Reservoir Accessories. Non-limiting examples of suitable ultrasonic flow rate sensors include SonoFlow® CO.55|Ultrasonic Clamp-On. Liquid volume and flow rate tracking may also be monitored using computer vision and pre-trained instance segmentation computer neural network (CNN). Using this method, the current volume in a transparent reactor using a contactless measurement system may be monitored by computer vision based on the pixel area of liquid to vessel. Computer vision may be used to track the fill line of the liquid contents of a transparent or translucent reactor.

In some aspects, the temperature in the reactor system may be monitored using a touchless temperature sensor. Non-limiting examples of suitable touchless temperature sensors include infrared temperature sensors. Exemplary commercially available temperature sensors include Melexis Technologies NV part number MLX90614KSF-ACC-000-TU-ND.

A reactor system of the instant invention can also comprise a temperature control device adapted to control the temperature of the reaction medium. The temperature control device can control temperature by conductive, thermoelectric, resistance heating, impedance, temperature modulation using induction, microwave dielectric heating and any combination thereof. Non-limiting examples of a temperature control device include heat exchanger plates or other heating elements on the exterior of the reactor, heating elements in the reaction chamber, and fluid jackets surrounding the reactor adapted to regulate the temperature of the reaction medium, by providing sources of heating and cooling.

The reactor system can further comprise a controller in functional communication with components of the apparatus such as the agitator assembly, valves, and sensors, and is operable to provide tight control of the operational sequence of the process on parameters such as temperature and pH. For instance, a controller can perform one or more of the following functions: allow switching on or off components of the system such as a fluid discharge valve, reaction medium inlet valve, agitator assembly, provide controls for system function such as agitator speed, system for raising and lowering of an agitator arm, and provide monitoring information using data collected by the sensors. The controller can include additional input and output components that permit input by a user (e.g., a touch screen display, a keyboard, a keypad, a mouse, a button, a switch, a microphone, etc.). The controller can also include output components that provide output information (e.g., a display, a speaker, one or more light-emitting diodes (LEDs), etc.).

In addition to the controller, the device can further comprise at least one processor and associated memory adapted to receive the operational and sensor data from the controller. The processor and associated memory can be hard wired to the system or can be networked in a wired or wireless manner. The processor and associated memory can also communicate with a server or other remote computing device in order to execute specific steps. A non-transitory computer readable medium programmed to execute the methods can be loaded on the processor and associated memory or in communication with the system. In some aspects, the processor can be operable to assign one or more event times, wherein each event time indicates the time of a change in the state of a signal received from a component of the system or a sensor. In this aspect, the associated memory can be operable to receive and store the signals and/or outputs of the sensors of the device, and the one or more event times. The storage component may store information and/or software related to the operation and use of the controller. The storage component can include a random-access memory (RAM), a read only memory (ROM), and/or another type of dynamic or static storage device (e.g., a flash memory, a magnetic memory, an optical memory, etc.) that stores information and/or instructions for use by the controller.

In some aspects, it is contemplated that the processor can comprise an alarm system that can be activated in response to one or more inputs from a sensor. In these aspects, it is contemplated that the alarm system can comprise a conventional device for selectively generating optical, thermal, vibrational, and/or audible alarm signals.

In some aspects, when the reactor system is attached to and used in conjunction with a POD unit operable for production of a pharmaceutical ingredient, the controller can be adapted to communicate data with at least one processor and associated memory of the POD unit. For instance, the controller can be operable to communicate a signal to the processor and memory of the POD unit in response to sensor data indicating moisture level in the filter cake. In such instance, the POD unit can switch off the pressure and/or vacuum input in response to a signal received from the treatment system controller, indicating a desired moisture level is reached.

### (f) Aspects of the Reactor

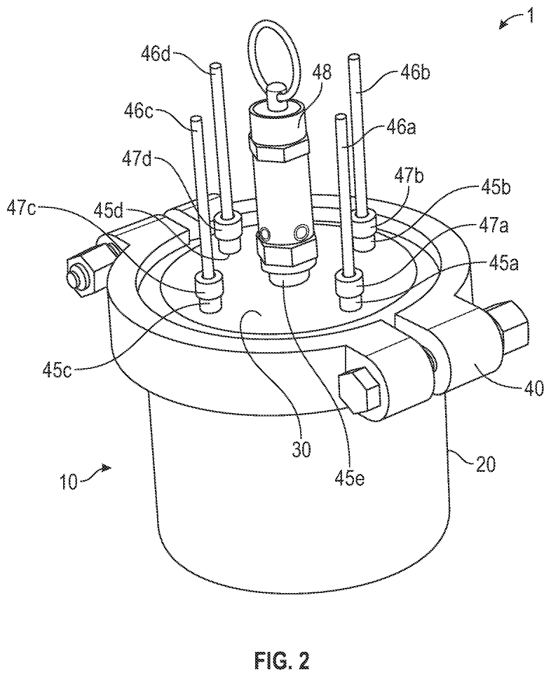

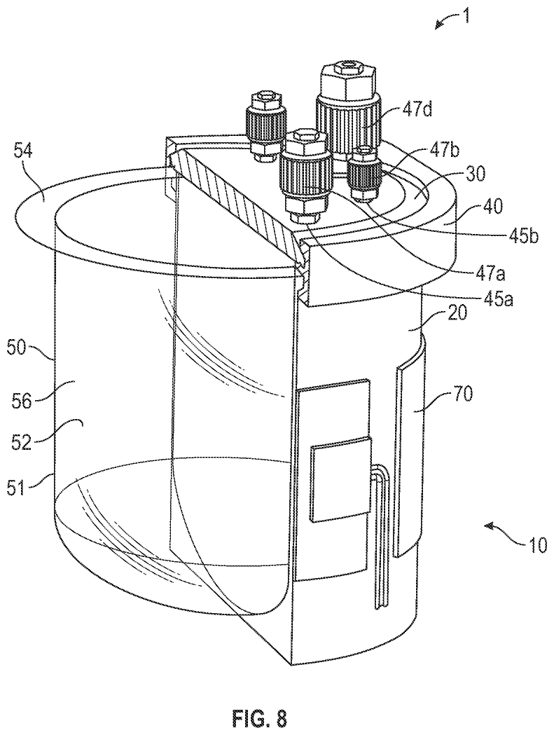

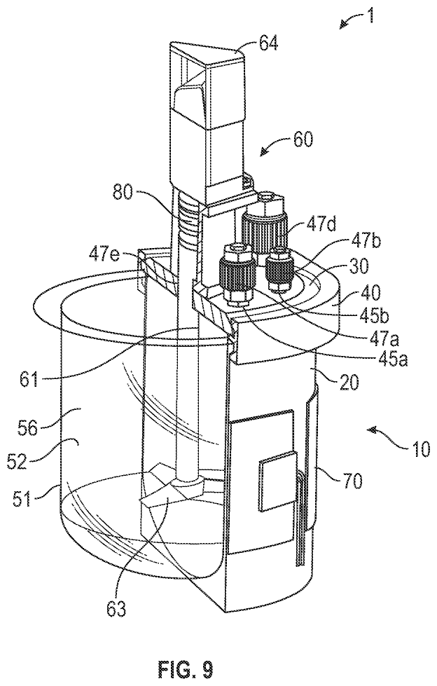

Aspects of a reactor liner 50, reactor 10, and reactor system 1 of the present invention are shown in FIGS. 2-9.

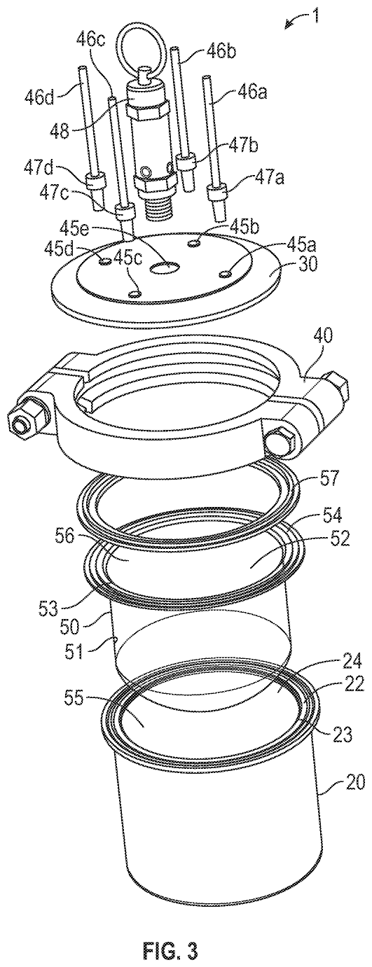

An aspect of the reactor 1 is shown in FIGS. 2-4 and 6-9. The reactor 10 comprises a vessel 20 and a lid 30. The vessel 20 comprises a vessel opening 23 and an interior surface 24 defining a vessel interior space 55 in which the interior surface 24 can be covered by the removable liner 50 (shown in FIGS. 3-9). The vessel 20 also comprises a sealing rim 22 defining the opening 23 of the vessel 20. A sanitary clamp 40 releasably seals the lid 30 to the vessel 20 and/or liner 50. In this aspect, the reactor 1 comprises five ports 45a-e in the lid 30. The five ports 45a-e comprise three material input ports 45a-c with material input tubing 46a-c inserted through each of the three input ports 45a-c, and an output port 45d with an output tubing 46d inserted through the output port.

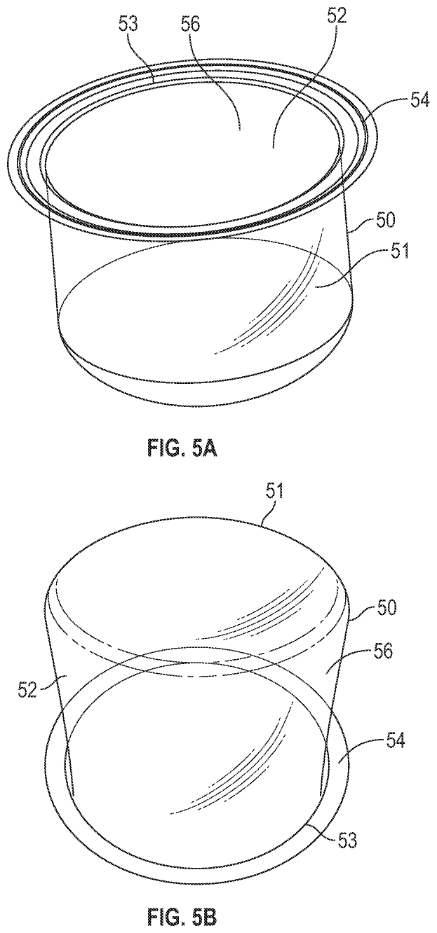

An aspect of the liner 50 is shown in FIG. 5A and FIG. 5B. As shown in FIG. 5A, the liner 50 comprises a liner body 51 defining a liner interior space 52 and a liner opening 53. The interior space 52 of the liner 50 forms a reaction compartment 56. In this aspect, the liner 50 comprises a lip 54. FIG. 5B depicts a photograph of the liner 50 in FIG. 5A.

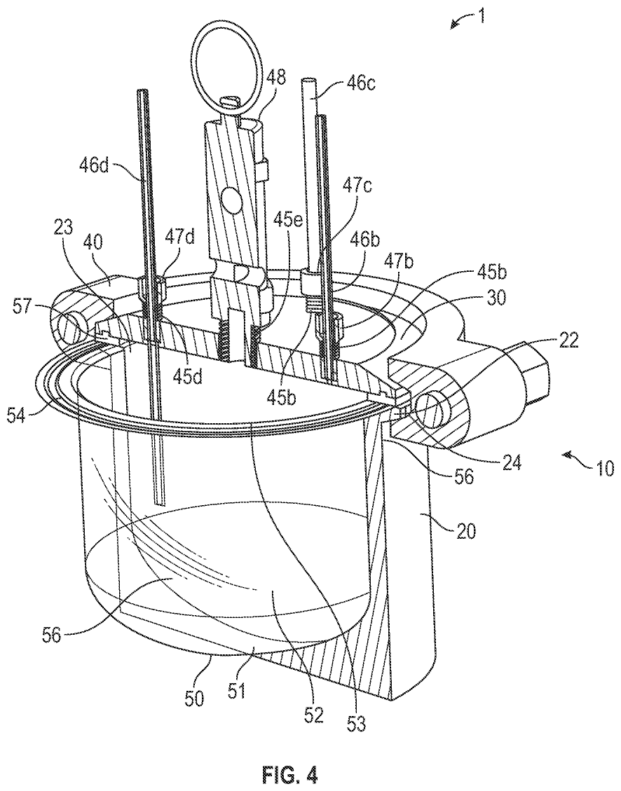

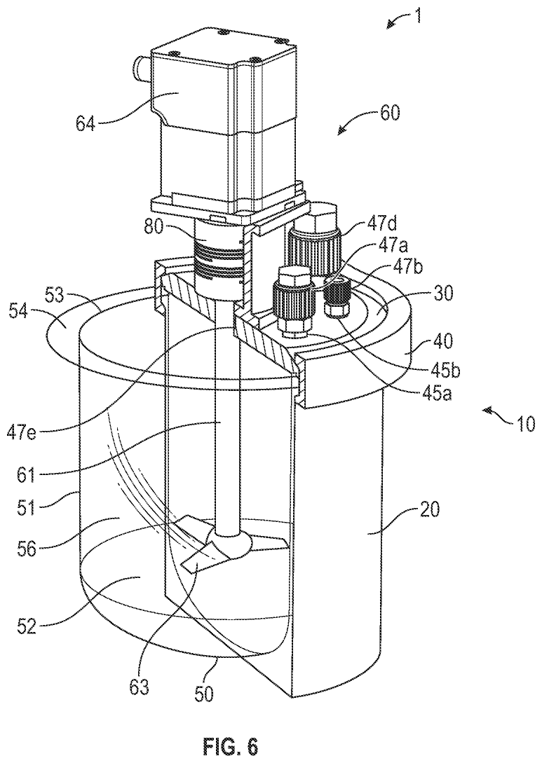

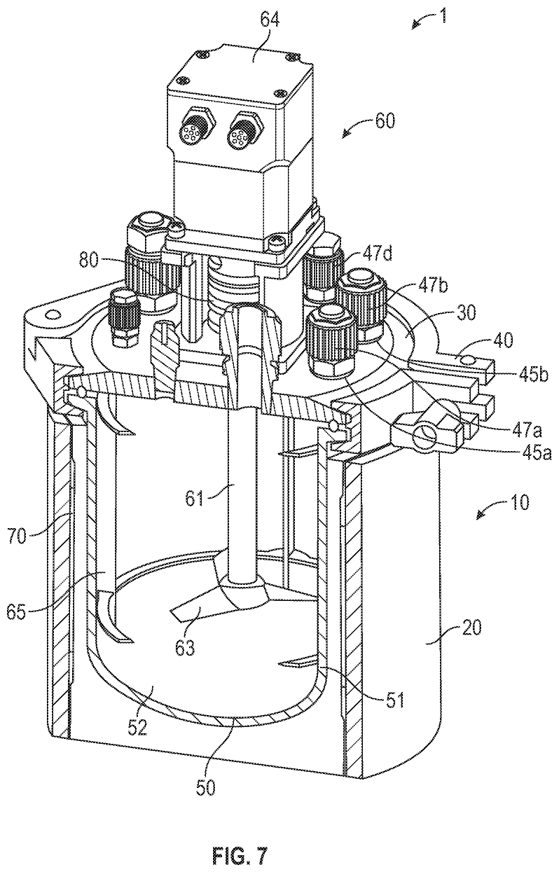

A reactor system 1 comprising a liner 50 removably lining the interior surface 24 of the vessel 20 of the reactor 10 is shown in FIGS. 4, and 6-9. FIG. 3 shows an exploded view of the reactor system 1 showing the liner 50 and reactor 10 of the reactor system 1. The interior space 52 of the liner 50 forms a reaction compartment 56 in the vessel interior space 55 of the reactor vessel 20. In this aspect, the liner 50 comprises a lip 54 encircling the liner opening 53 and a gasket 57 interposed between the lid 30 and the vessel rim 23. When the lid 30 and the vessel 20 are sealed, the lip 54 and gasket 57 are interposed between the lid 30 and the vessel 20 at the sealing rim 23 to form a tight seal. The aspect of the reactor system 1 in FIG. 6 does not comprise a gasket 57. In FIGS. 7, 8, and 9, an aspect of a reactor system 1 comprising a temperature control jacket 70 is shown.

In FIGS. 2, 3, and 4, an aspect of the reactor system 1 is shown, wherein the reactor system 1 further comprises a pressure relief valve 48 attached to an attachment port 45e in fluid communication with the interior space 52 (shown in FIG. 3) of the liner 50.

FIGS. 6, 7 and 9 show an aspect of the reactor system 1 further comprising an overhead stirrer 60. An overhead stirrer 60 generally comprises a shaft 61 which extends through attachment port 47e (not shown in FIG. 7) into the interior space 52 of the liner 50. The shaft 61 comprises an impeller 63 disposed in the interior space 55 of the vessel 20 for stirring or agitating a reaction medium (not shown). A mixing motor 64 is shown attached to the shaft 61 through a flexible coupling 80. In FIG. 7, the stirrer 60 further comprises baffles 65 attached to the lid 30.

### II. Methods

The instant invention is also directed to a method of manufacturing a compound using a removable liner and a reactor system comprising the removable liner to perform a chemical reaction within the reactor in a process of manufacturing the compound. The removable liner and a reactor system comprising the removable liner can be as described in Section I herein above. The chemical reaction can be a reaction for producing a chemical compound, a biological compound, an active pharmaceutical compound (API), and a formulated drug product. In some aspects, the chemical reactant is an API. In some aspects, the chemical reactant can be a precursor of an active pharmaceutical ingredient.

In some aspects, a method of synthesizing a chemical compound comprises providing or having provided one or more input materials; introducing the one or more input materials into the reaction compartment of the removable liner in a reactor input stream; and subjecting the one or more input materials in the reaction compartment to conditions to cause a chemical reaction between the input materials. Reaction media comprising the resulting chemical compound is harvested from the reactor in a reactor output stream comprising the synthesized chemical compound.

The chemical compound can be an active pharmaceutical compound (API) or a precursor of an API. The one or more of the input materials can be a product of a chemical reaction conducted in a second reactor fluidically connected with the reactor. Further, the reactor can be fluidically connected with other modules fluidically connected with the reactor, wherein the modules perform the same or different chemical processes or unit operations to produce chemical products. The modules can be multiple reactors or reactor systems of the same or different types. The modules can comprise separators, filter-washer-dryers, gravity separators, crystallizers, tableters, and the like. Some aspects comprise transporting a fluid (e.g., a chemical reagent, a solvent, or combinations thereof) through the one or more modules fluidically connected in series or in parallel, or combinations thereof. Some aspects comprise transporting a first fluid (e.g., a chemical reagent, a solvent, or combinations thereof) through a first module and a second module fluidically connected to the first module to form a first chemical product (which is output from the second module).

Chemical reagents, solvents, and other variables necessary for synthesizing a compound can and will vary depending on the compound and the method of synthesis used to synthesize the compound. Any suitable chemical reagent can be used in the systems and methods described herein. Generally, the type of reagent that is employed in the system will depend on the chemical product of interest.

Chemical reactants and/or chemical products can be transported into and/or out of the reactor(s) in any suitable form. In certain aspects, one or more of the chemical reactants and/or chemical products transported through the reactors is in the form of one or more solutes. In certain aspects, the solute (e.g., the chemical reactant and/or the chemical product) may be present at a relatively high concentration. For example, in some aspects, a chemical reactant and/or a chemical product may be present at a concentration of greater than or equal to about 1 M. In certain aspects, a chemical reactant and/or a chemical product may be present in an amount close to the saturation limit (e.g., within 90%, within 95%, or within 99% of the saturation limit) of the chemical reactant and/or of the chemical product. As will be understood by those skilled in the art, the saturation limit generally refers to the concentration of a solute before the solute begins to precipitate from solution (i.e., form a solid phase of the solute). Several advantages of using fluids comprising a high concentration of solutes, as compared to batch processes where dilute solutes are dissolved and/or suspended in a carrier fluid, include increasing productivity and/or processed materials rates and reducing waste and formation of byproducts (e.g., solid precipitates).

In certain aspects, any of the methods for the production of a chemical product (e.g., an ingestible pharmaceutical composition) described herein can be continuous processes using the reactor as one module in a complete system. In some aspects, the method for the continuous production of the chemical product (e.g., the ingestible pharmaceutical composition) comprises transporting an input fluid comprising a chemical reactant through one or more reactors of the present invention. In certain aspects, a chemical reactant is reacted, within the reactor, to produce the chemical product (e.g., an API) within the reactor output stream.

Continuous processes generally refer to systems in which precursor enters the system, product exits the system, and the transformation the system is designed to achieve all occur during at least a portion of the time during which the transformation occurs. As one example, in a continuous reactor system, reaction precursor enters the reactor and reaction product exits the reactor during at least a portion of the time that the chemical reaction within the reactor is taking place.

Continuous systems that include two or more modules or kits (e.g., reactors, reactor systems, separators, and the like) which are fluidically connected via one or more conduits that can be arranged such that transport between the module within the continuous system occurs during at least a portion of the time during which the modules are performing their intended function (e.g., reaction for a reactor, separation for a separator, etc.).

In some aspects, a chemical product is produced continuously from one or more precursors of the chemical product when precursors of the chemical product are being transported into the continuous system and chemical product is being transported out of the continuous system during at least portions of the times the components of the continuous system are being operated to produce the finished chemical product. The conditions prevailing within the internal reactor can be judiciously selected, controlled, and/or maintained, suitably by controlling one or more reaction parameters (e.g. temperature, pressure, residence time, mixing). The dimensions and shape of the internal reactor may be optionally adjustable, to control one or more reaction parameters. A variable volume reactor of the instant invention greatly facilitates this process. The internal reactor may be (optionally adjustably) dimensioned and/or shaped to provide a desired reaction mixture “residence time” (i.e. the volumetric residence time of the reaction mixture, which is the ratio of the reactor's internal volume and the overall volumetric flow rate of the reaction mixture through the reactor—i.e. where overall volumetric flow rate is suitably the sum of the flow rates of the first and second input loads). Naturally, this “residence time” may also be influenced by the overall flow rate, which may be altered by adjusting the flow rate of the individual input loads. In this context, “residence time” is generally a measure of the duration of reaction within the internal reactor (i.e. the time taken for a given volume of reaction mixture to pass through the reactor). In some aspects, the chemical reaction may take place at a particular volumetric flow rate throughout the reactor. In certain aspects, the flow rate is a variable flow rate. In some aspects, the flow rate is a constant flow rate. In some aspects, the chemical reaction takes place within a reactor at a flow rate ranging between less than or about 0.1 to about 2000 ml/min, or from about 1 to about 1000 ml/min. In certain aspects, the chemical reaction takes place within a reactor at a flow rate of about 1 ml/min, about 10 ml/min, about 20 ml/min, about 30 ml/min, about 40 ml/min, about 50 ml/min, about 60 ml/min, about 70 ml/min, about 80 ml/min, about 90 ml/min, about 100 ml/min, about 200 ml/min, about 300 ml/min, about 400 ml/min, about 500 ml/min, about 600 ml/min, about 700 ml/min, about 800 ml/min, about 900 ml/min, about 1000 ml/min, or more. Other flow rates are also possible.

The reactor systems of the instant invention may be operated to induce, adjust, and/or maintain one or more reaction parameters within the reaction medium. For instance, where the reactor system comprises or is associated with a heating or cooling device, the temperature within the reaction medium may be selected, maintained, or adjusted—it may be particularly important to apply cooling or otherwise allow heat-exchange to remove heat generated during a reaction by exotherms. Where the reactor system comprises or is associated with a pressure adjusting device (e.g., a vacuum pump or autoclave), the pressure (or lack thereof) within the reaction chamber may be selected, maintained, or adjusted. Where the reactor system comprises an agitation element (e.g., for mixing), mixing of the reaction medium may be facilitated. Where the reactor system is configured to receive input from one or more further input flow lines, prevailing reaction conditions (e.g., pH) within the reaction chamber (and therefore of the reaction mixture) may be selected, maintained, or adjusted.

Alternatively, where the reactor system comprises a gas outlet or gas output flow line (as distinct from a reaction medium output flow line), optionally connected to a scrubber (e.g., soda lime scrubber for scrubbing excess), gaseous input material(s) and/or gaseous output materials (produced following the chemical reaction) may be conveniently diverted so that an output load (carrying output material(s)) exiting the reactor comprises a reduced concentration of said gaseous materials relative to the concentration of said gaseous materials in the reaction medium (i.e. within the reactor of the reactor system).

In some aspects, the removable liner and the reactor system of the present invention is used in connection with miniature chemical or pharmaceutical manufacturing units, pharmaceutical on demand (POD) units. POD units are comprised of a number of individual production modules that interact with one another in order to perform one or more steps in a chemical production process. In some aspects, the POD units are sufficiently small such that they are suitable for manufacturing pharmaceuticals or finished drug products which are to be directly distributed and/or deployed to pharmacies, hospitals and to consumers rather than depend on pharmaceuticals from a large manufacturing plant.

When the reactor system comprises a touchless monitoring system, methods of the instant invention can further comprise applying touchless measurements to the reactor to provide real-time monitoring of process parameters to ensure that the chemical reaction progresses within specified limits, thus contributing to process efficiency, selectivity, yield and safety. Measurement systems that can be used for touchless measurements can be as described in Section I(e) herein above. Process variables, such as temperature, pressure, concentration, and rate of reagent or solvent addition can be adjusted in an adaptive response to the real time, or near real time, touchless measurements. Temperature and pressure may be monitored using a thermocouples and pressure sensors, respectively. Spectroscopic measurements including near-infrared, mid-infrared, Raman, and UV spectroscopy, may be used to monitor for the presence or disappearance of functional groups during the synthesis. By monitoring the specific functional groups, qualitative trending or quantitative assessment of the reaction component levels is achieved. Additionally, by integrating automated, real-time process control, real-time data can be acquired for process monitoring and applied to process control for ensuring product quality. This approach provides improved real-time control of the reaction progress ensuring the reaction parameters remain within specifications.

In other aspects, such separation of gases (and optional scrubbing) may occur downstream from the reactor system, suitably at a collector point (where the output load is collected). Such induction, adjustment, and/or maintenance of one or more reaction parameters within the internal reactor may suitably further facilitate a chemical reaction within the reaction compartment.

According to certain aspects, certain of the systems and methods described herein can be used to produce an ingestible pharmaceutical composition. A method for the production of an ingestible pharmaceutical composition may comprise, in some aspects, transporting an input fluid comprising a chemical reactant through a reactor system module via a conduit which is fluidically connected in and out of the module such that the chemical reactant is reacted, within the reaction compartment of the removable liner, to produce an active pharmaceutical ingredient within a reactor output stream.

In some aspects, the fluid transported into the reactor system of the present invention, as described above, comprises a solvent. Solvents can be aprotic solvents, protic solvents, organic solvents, and any combination thereof. Non-limiting examples of suitable aprotic solvents include acetone, acetonitrile, diethoxymethane, N,N-dimethylformamide (DMF), dimethyl sulfoxide (DMSO), N,N-dimethylpropionamide, 1,3-dimethyl-3,4,5,6-tetrahydro-2(1H)-pyrimidinone (DMPU), 1,3-dimethyl-2-imidazolidinone (DMI), 1,2-dimethoxyethane (DME), dimethoxymethane, bis(2-methoxyethyl)ether, N,N-dimethylacetamide (DMAC), 1,4-dioxane, N-methyl-2-pyrrolidinone (NMP), ethyl acetate, ethyl formate, ethyl methyl ketone, formamide, hexachloroacetone, hexamethylphosphoramide, methyl acetate, N-methylacetamide, N-methylformamide, methylene chloride, nitrobenzene, nitromethane, propionitrile, sulfolane, tetramethylurea, tetrahydrofuran (THF), 2-methyl tetrahydrofuran, trichloromethane, and combinations thereof. Suitable examples of protic solvents include, but are not limited to, methanol, ethanol, isopropanol, n-propanol, isobutanol, n-butanol, s-butanol, t-butanol, formic acid, acetic acid, water, and combinations thereof. Suitable organic solvents include, but are not limited to, alkane and substituted alkane solvents (including cycloalkanes), aromatic hydrocarbons, esters, ethers, ketones, combinations thereof, and the like and any combination thereof. Organic solvents that may be employed, include, for example, acetonitrile, benzene, butyl acetate, t-butyl methylether, t-butyl methylketone, chlorobenzene, chloroform, chloromethane, cyclohexane, dichloromethane, dichloroethane, diethyl ether, ethyl acetate, diethylene glycol, fluorobenzene, heptane, hexane, isobutylmethylketone, isopropyl acetate, methylethylketone, methyltetrahydrofuran, pentyl acetate, n-propyl acetate, tetrahydrofuran, toluene, and any combination thereof.

It will be understood by those of ordinary skill in the art that the reactors of the present invention can be used to synthesize an active pharmaceutical ingredient (“API”). As used herein, the term “active pharmaceutical ingredient” (also referred to as a “drug”) refers to an agent that is administered to a subject to treat a disease, disorder, or other clinically recognized condition, or for prophylactic purposes, and has a clinically significant effect on the body of the subject to treat and/or prevent the disease, disorder, or condition. Active pharmaceutical ingredients include, without limitation, agents listed in the United States Pharmacopeia (USP). In some aspects, the active pharmaceutical ingredient is one that has already been deemed safe and effective for use in humans or animals by the appropriate governmental agency or regulatory body. For example, drugs approved for human use are listed by the FDA under 21 C.F.R. §§ 330.5, 331 through 361, and 440 through 460, incorporated herein by reference; drugs for veterinary use are listed by the FDA under 21 C.F.R. §§ 500 through 589, incorporated herein by reference. All listed drugs are considered acceptable for use in accordance with the present invention.

In certain aspects, the active pharmaceutical ingredient is a small molecule. Exemplary active pharmaceutical ingredients include, but are not limited to, adrenergic blocking agents, anabolic agents, androgenic steroids, antacids, anti-asthmatic agents, anti-allergenic materials, anti-cholesterolemic and anti-lipid agents, anti-cholinergics and sympathomimetics, anti-coagulants, anti-convulsants, anti-diarrheal, anti-emetics, anti-hypertensive agents, anti-infective agents, anti-inflammatory agents such as steroids, non-steroidal anti-inflammatory agents, antimalarials, anti-manic agents, anti-nauseants, anti-neoplastic agents, anti-obesity agents, anti-parkinsonian agents, anti-pyretic and analgesic agents, anti-spasmodic agents, anti-thrombotic agents, anti-uricemic agents, anti-anginal agents, antihistamines, anti-tussives, appetite suppressants, benzophenanthridine alkaloids, biologicals, cardioactive agents, cerebral dilators, coronary dilators, decongestants, diuretics, diagnostic agents, erythropoietic agents, estrogens, expectorants, gastrointestinal sedatives, agents, hyperglycemic agents, hypnotics, hypoglycemic agents, ion exchange resins, laxatives, mineral supplements, mitotics, mucolytic agents, growth factors, neuromuscular drugs, nutritional substances, peripheral vasodilators, progestational agents, prostaglandins, psychic energizers, psychotropics, sedatives, stimulants, thyroid and anti-thyroid agents, tranquilizers, uterine relaxants, vitamins, antigenic materials, and prodrugs, etc. Non-limiting examples of APIs include propofol, midazolam, cisatracurium, ciprofloxacin, and others.

As used herein, the term “small molecule” refers to molecules, whether naturally occurring or artificially created (e.g., via chemical synthesis), that have a relatively low molecular weight. Typically, a small molecule is an organic compound (i.e., it contains carbon). The small molecule may contain multiple carbon-carbon bonds, stereocenters, and other functional groups (e.g., amines, hydroxyl, carbonyls, and heterocyclic rings, etc.). In certain aspects, the molecular weight of a small molecule is at most about 1,000 g/mol, at most about 900 g/mol, at most about 800 g/mol, at most about 700 g/mol, at most about 600 g/mol, at most about 500 g/mol, at most about 400 g/mol, at most about 300 g/mol, at most about 200 g/mol, or at most about 100 g/mol. In certain aspects, the molecular weight of a small molecule is at least about 100 g/mol, at least about 200 g/mol, at least about 300 g/mol, at least about 400 g/mol, at least about 500 g/mol, at least about 600 g/mol, at least about 700 g/mol, at least about 800 g/mol, or at least about 900 g/mol, or at least about 1,000 g/mol. Combinations of the above ranges (e.g., at least about 200 g/mol and at most about 500 g/mol) are also possible.

Also as noted above, the removable liner and the reactor system comprising the removable liner can be used with modular systems and the methods described herein can be used to produce ingestible pharmaceutical compositions. Generally, ingestible pharmaceutical compositions refer to those compositions including an active pharmaceutical ingredient and a pharmaceutically acceptable excipient. As used herein, the term “pharmaceutically acceptable excipient” means a non-toxic, inert solid, semi-solid or liquid filler, diluent, encapsulating material or formulation auxiliary of any type. Some non-limiting examples of materials which can serve as pharmaceutically acceptable excipients are sugars such as lactose, glucose, and sucrose; starches such as corn starch and potato starch; cellulose and its derivatives such as sodium carboxymethyl cellulose, methylcellulose, hydroxypropylmethylcellulose, ethyl cellulose, and cellulose acetate; powdered tragacanth; malt; gelatin; talc; excipients such as cocoa butter and suppository waxes; oils such as peanut oil, cottonseed oil; safflower oil; sesame oil; olive oil; corn oil and soybean oil; glycols such as propylene glycol; esters such as ethyl oleate and ethyl laurate; agar; detergents such as Tween 80; buffering agents such as magnesium hydroxide and aluminum hydroxide; alginic acid; water (e.g., pyrogen free water); isotonic saline; citric acid, acetate salts, Ringer's solution; ethyl alcohol; and phosphate buffer solutions, as well as other non-toxic compatible lubricants such as sodium lauryl sulfate and magnesium stearate, as well as coloring agents, releasing agents, coating agents, sweetening, flavoring and perfuming agents, preservatives and antioxidants can also be present in the composition, according to the judgment of the formulator.

The removable liner and the reactor system comprising the removable liner can also be used with modular systems and the methods described herein to produce pharmaceutical compositions for parenteral administration (including subcutaneous, intradermal, intravenous, intramuscular, and intraperitoneal). Formulations for parenteral administration can be an aqueous or an oil-based solution. Aqueous solutions may include a sterile diluent such as water, saline solution, a pharmaceutically acceptable polyol such as glycerol, propylene glycol, or other synthetic solvents; an antibacterial and/or antifungal agent such as benzyl alcohol, methyl paraben, chlorobutanol, phenol, thimerosal, and the like; an antioxidant such as ascorbic acid or sodium bisulfite; a chelating agent such as etheylenediaminetetraacetic acid; a buffer such as acetate, citrate, or phosphate; and/or an agent for the adjustment of tonicity such as sodium chloride, dextrose, or a polyalcohol such as mannitol or sorbitol. The pH of the aqueous solution may be adjusted with acids or bases such as hydrochloric acid or sodium hydroxide. Oil-based solutions or suspensions may further comprise sesame, peanut, olive oil, or mineral oil.

For topical (e.g., transdermal or transmucosal) administration, penetrants appropriate to the barrier to be permeated are generally included in the preparation. Transmucosal administration may be accomplished through the use of nasal sprays, aerosol sprays, tablets, or suppositories, and transdermal administration may be via ointments, salves, gels, patches, or creams as generally known in the art.

Typical applications: Hydrogenation reactor, Polymerization reactor, Synthesis reactor, Catalyst testing/evaluation, Catalytic reactor, Corrosion measurement, Crystallization, Chemical research, Petrochemical research, Biopolymer Research, Nanoparticle synthesis, Corrosion testing autoclave.

### III. Kits

Aspects of the invention further encompass kits of removable liners, reactors that can be used with the removable liners, reactor systems comprising reactors and removable liners, and any combination thereof. The removable liners, the reactor systems, and the reactors can be of different sizes, shapes and configurations. The kits can include one or more removable liners, one or more reactors that can be used with the removable liners, one or more reactor systems comprising one or more liners, one or more reactor tubings, one or more sensors, filters, connectors, probes, samplers, means of attaching the reactor to additional devices or systems, or other devices, and combinations thereof. The one or more removable liners, reactor systems comprising removable liners, and reactors that can be used with the removable liners can be of different sizes, reactor bodies, and liners constructed of different materials or combination of materials. Tubing of the kit can include tubing of different external diameters, internal diameters, material, lengths, and combinations thereof.

The kits can further comprise other components to which the reactors can connect to produce an active pharmaceutical product. Non-limiting examples of components include feedstock reagent kits or reservoirs, heaters, valves, flow meters, cameras, scales, spectrometers, waste reservoirs, separators, crystallization kits, purification kits, pumps, inline mixers, pressure transducers, and controllers. In some aspects, the reactor of the present invention is included within a reactor module or kit. The reactor modules can comprise the CSTRs of the present invention, mixing chamber, or tube style reactors or any combination thereof.

### Definitions

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them unless specified otherwise.

When introducing elements of the present invention or the preferred aspects(s) thereof, the articles “a”, “an”, “the” and “said” are intended to mean that there are one or more of the elements. The terms “comprising”, “including” and “having” are intended to be inclusive and mean that there may be additional elements other than the listed elements.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant, both in relation to the other endpoint, and independently of the other endpoint.

As used herein, the term “reactor” refers to any device comprising a vessel in which chemical or biologically active environments can be controlled. A bioreactor is a vessel in which a chemical process is carried out which involves organisms or biochemically active substances derived from such organisms. This process can either be aerobic or anaerobic. It may also refer to a device or system designed to grow cells or tissues in the context of cell culture. A chemical reactor is a vessel in which a chemical reaction takes place.

As used herein, the term “reaction” refers to any chemical or biological process in which one or more substances, also called reactants, are converted to one or more different substances, known as products. Substances are either chemical elements or compounds, or biological elements such as cells and tissues. Such reactions can take place in a reaction medium comprising the substances, solvents, nutrients, and any other element that may be necessary for the reaction to occur.

As various changes could be made in the above-described cells and methods without departing from the scope of the invention, it is intended that all matter contained in the above description and in the examples given below, shall be interpreted as illustrative and not in a limiting sense.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

### EXAMPLES

All patents and publications mentioned in the specification are indicative of the levels of those skilled in the art to which the present disclosure pertains. All patents and publications are herein incorporated by reference to the same extent as if each individual publication was specifically and individually indicated to be incorporated by reference.

The publications discussed throughout are provided solely for their disclosure before the filing date of the present application. Nothing herein is to be construed as an admission that the invention is not entitled to antedate such disclosure by virtue of prior invention.

The following examples are included to demonstrate the disclosure. It should be appreciated by those of skill in the art that the techniques disclosed in the following examples represent techniques discovered by the inventors to function well in the practice of the disclosure. Those of skill in the art should, however, in light of the present disclosure, appreciate that many changes could be made in the disclosure and still obtain a like or similar result without departing from the spirit and scope of the disclosure, therefore all matter set forth is to be interpreted as illustrative and not in a limiting sense.

### Example 1. Production of Cisatracurium in a Pharmaceutical on Demand (POD) Unit

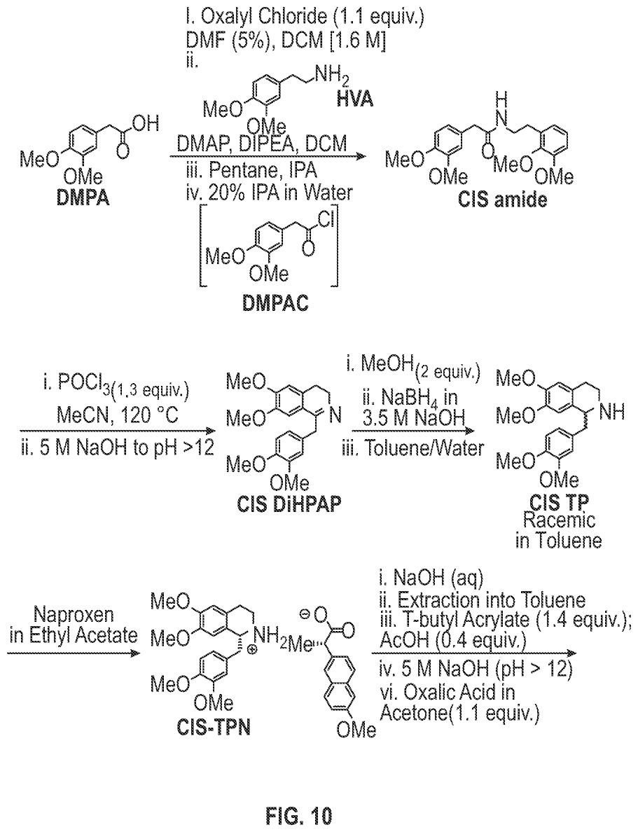

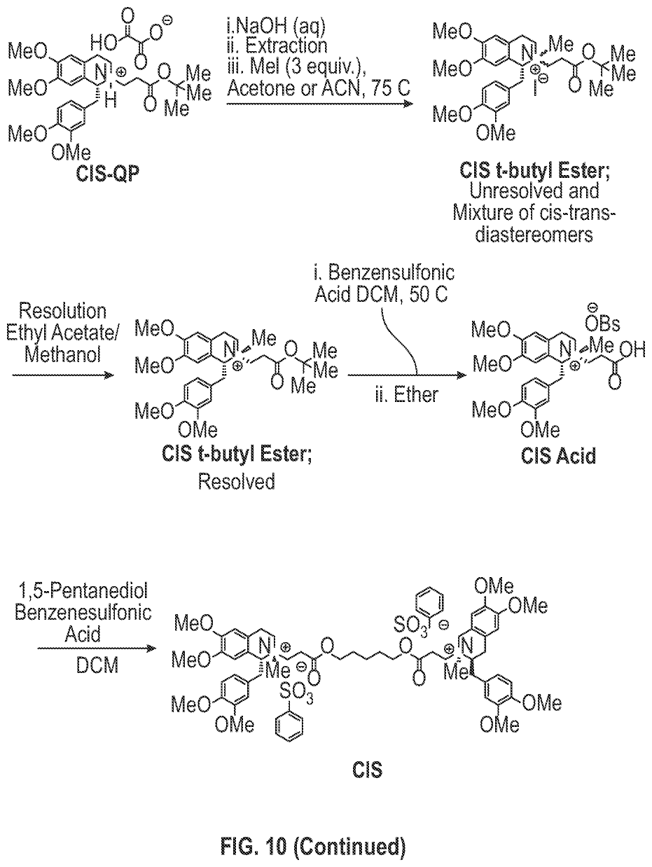

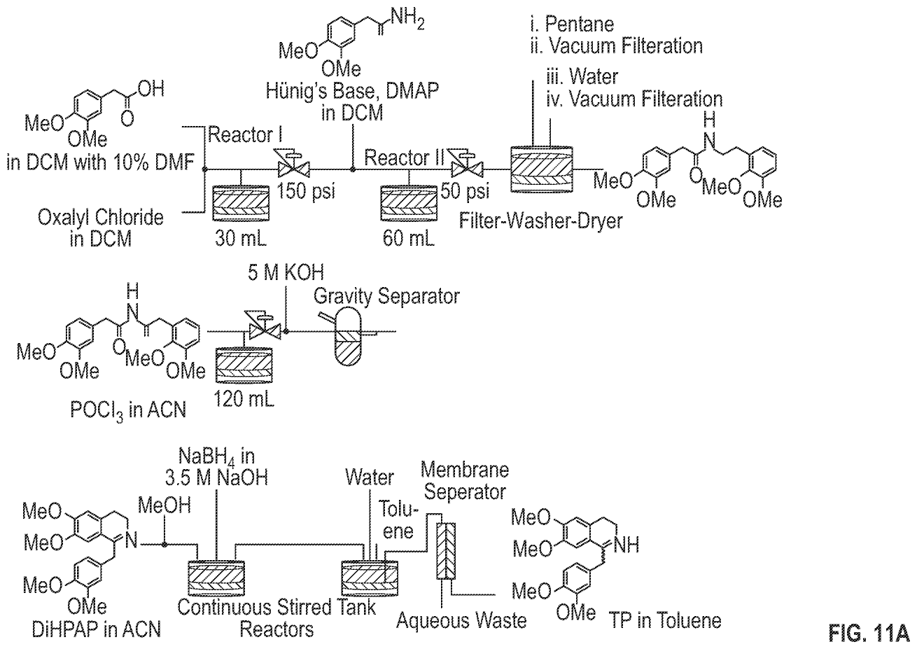

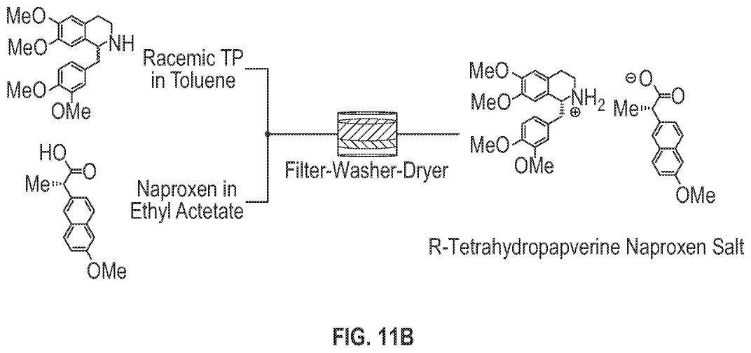

In an aspect, cisatracurium besylate is made in a continuous process and the chemical process is depicted schematically in FIG. 10. As shown in FIG. 11A, in a first CSTR of the present invention, dimethoxy phenylacetic acid is reacted with oxalyl chloride in dichloromethane, and then the chlorinated product DMPAC is then reacted in a second reactor of the present invention with homovanillic acid which is then pumped into a filter-washer-dryer to create the precursor cis-amide. After this reaction is completed, with the STRs of the present invention, one can now clean this system by flushing the system with solvent and removing the liners of the STRs and replacing with clean liners. The next set of reactions can then be performed in the system. Cis-amide is combined in POCl3 with acetonitrile (ACN) in a CSTR and then the effluent is mixed with 5M KOH to neutralize and then is separated to give dihydroxy papaverine (DIHPAP) in ACN. The resulting DIHPAP is mixed with NaHB4 and NaOH in a CSTR to reduce the nitrogen, which is then pumped into a third CSTR with water and toluene to give racemic R,S,-tetrahydropapverine (TP). As shown in FIG. 11B racemic R,S,-tetrahydropapaverine (TP) which is then separated with R,S naproxen to separate the R and S stereoisomers and produce the R-tetrahydropapaverine naproxen salt. The remaining reactions are illustrated in FIG. 10 which result in resolved 1R-cis, ‘R-cis-2,2’-(3,11 dioxo-4,10-dioxatridecylene)-bis-(1,2,3,4-tetrahydro-6,7 dimethoxy-2-methoxyl-1-veratrylisoquinolinium) salts.

### Example 2. Production of Ciprofloxacin in a Pharmaceutical on Demand (POD) Unit

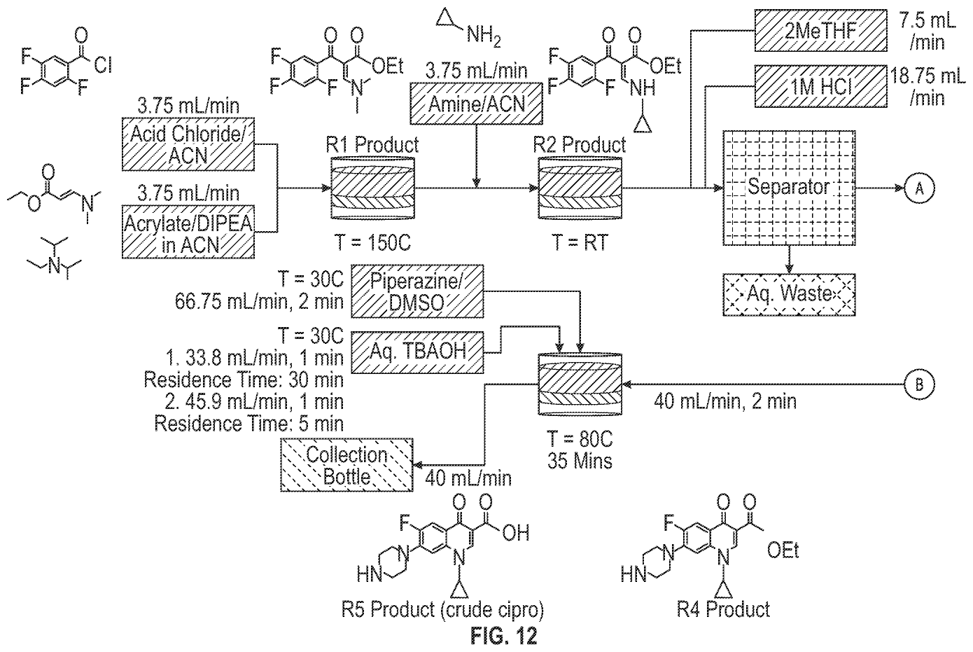

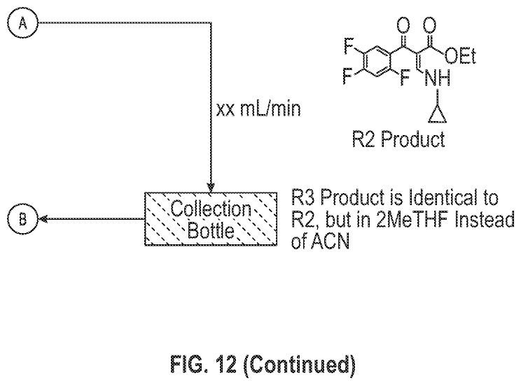

In an exemplary aspect, ciprofloxacin is made in a continuous process and the chemical process is depicted schematically in FIG. 12. Briefly, N,N-Diisopropylethylamine (DIEA) is mixed with acrylate and tri-fluoro benzyl chloride into a first CSTR of the present invention to make R₁, which is then reacted in series with cyclopropylamine in a second CSTR to make R₂, which is then dissolved in 2-methyl-THF and neutralized with HCl and added to a gravity separator to separate R₃ in the organic phase which is then pumped to a third CSTR where it is reacted with piperazine to make R₄, and then NaOH or other base to make the resulting crude ciprofloxacin API R₅. After these reactions are completed, with the STRs of the present invention, one can now clean this system by flushing the system with solvent and removing the liners of the STRs and replacing with clean liners. The same or a new set of reactions can then be performed using the CSTRs of the instant invention.

What is claimed is:

1. A stirred tank reactor system, the tank reactor system comprising:
a. a reactor comprising:
i. a vessel comprising an interior surface defining an interior space and a sealing rim defining a vessel opening;
ii. a lid releasably sealed to the vessel against the sealing rim of the vessel wherein the vessel and the lid form an enclosed reaction chamber within the reactor;
iii. a mechanical closure operable to releasably seal the lid to the vessel; and
iv. two or more ports in fluid communication with the reaction chamber of the reactor; and
b. a removable liner removably lining the interior surface of the vessel, the liner comprising a liner body defining an interior space and an opening, wherein the interior space of the liner forms a reaction compartment in the enclosed chamber.

2. The reactor system of claim 1, wherein the reactor is a continuous stirred tank reactor (CSTR).

3. The reactor system of claim 1, the liner further comprising a lip encircling the vessel opening, wherein the lip is interposed between the lid and the vessel at the sealing rim.

4. The reactor system of claim 1, wherein the liner comprises material comprising chemically inert polymers including inert fluoropolymers like polytetrafluoroethylene (PTFE), ethylene-tetrafluoroethylene (ETFE) or perfluoroalkoxy copolymer (PFA), and fluorinated ethylene propylene (FEP).

5. The reactor system of claim 1, wherein the liner comprises a thickness ranging from about 0.001 to about 0.1 inches, from about 0.002 to 0.02 in, or from about 0.05 to 0.08 in.

6. The reactor system of claim 1, further comprising a gasket interposed between the lid and sealing rim operable to releasably seal the lid to the vessel.

7. The reactor system of claim 6, wherein the gasket comprises material comprising elastomers, coated elastomers such as fluoropolymer-coated elastomeric gaskets, such as PTFE-coated viton.

8. The reactor system of claim 1, further comprising an agitator operable to agitate contents of the reactor system.

9. The reactor system of claim 8, wherein the agitator is selected from an overhead stirrer, a magnetic stirrer, and a shaking device.

10. The reactor system of claim 1, wherein the mechanical closure is selected from a band clamp, a sanitary clamp such as a Ladish or Rickover clamp, “Tri Clamps” or “Tri-clover” or “S-Clamp” or “3A pipe fittings”, mated threads, or combinations thereof.

11. The reactor system of claim 1, further comprising a temperature control device operable to control the temperature of reagents in the reaction space.

12. The reactor system of claim 11, wherein the temperature control device is selected from a conduction device, a thermoelectric device, a resistance device, an impedance device, an induction device, a microwave dielectric heating device, and any combination thereof.

13. The reactor system of claim 11, wherein the temperature control device comprises a jacket surrounding the vessel, a heat plate, a bath, or combinations thereof.

14. The reactor system of claim 1, wherein the lid comprises at least one material input port and at least one material output port.

15. The reactor system of claim 1, further comprising a pressure relief valve attached to an attachment port in the reactor lid, wherein the pressure relief valve is in fluid communication with the interior space of the liner.

16. The reactor system of claim 1, further comprising a pressure relief valve attached to an attachment port in the reactor lid, one or more sampling ports in the reactor lid, one or more sensors attached to sensor ports in the reactor lid.

17. The reactor system of claim 1, wherein a portion or all of the reactor vessel, a portion or all of the reactor lid, a portion or all of the removable liner, or any combinations thereof, is comprises translucent/transparent material.

18. A removable reactor liner for removably lining an interior surface of a reactor, the liner comprising a liner body defining an interior space and an opening, wherein the interior space of the liner forms a reaction compartment in an enclosed chamber of the reactor.

19. The removable reactor liner of claim 18, the liner further comprising a lip encircling an opening in a vessel of a reactor, wherein the lip is interposed between a lid and the vessel of the reactor at a sealing rim of the vessel.

20. The removable reactor liner of claim 18, wherein the liner comprises material comprising chemically inert polymers including inert fluoropolymers like polytetrafluoroethylene (PTFE), ethylene-tetrafluoroethylene (ETFE) or perfluoroalkoxy copolymer (PFA), and fluorinated ethylene propylene (FEP).

21. The removable reactor liner of claim 18, wherein the liner comprises a thickness ranging from about 0.001 to about 0.1 inches, from about 0.002 to 0.02 in, or from about 0.05 to 0.08 in.
